(19) United States
(12) Patent Application Publication
(10) Pub. No.: US 2007/0109472 A1
(43) Pub. Date: May 17, 2007

(54) Thin film transistor array, transflective thin film transistor liquid crystal display, LCD device and electronic device

(75) Inventors: Li-Sen Chuang, Penghu City (TW); Wei-Chih Chang, Jhubei City (TW)

Correspondence Address: LIU & LIU, 444 S. FLOWER STREET, SUITE 1750, LOS ANGELES, CA, 90071, US

(73) Assignee: Toppoly Optoelectronics Corp.

(21) Appl. No.: 11/281,310

(22) Filed: Nov. 17, 2005

(51) Int. Cl. G02F 1/1335

(52) U.S. Cl. 349/114

(57) ABSTRACT

A thin film transistor array substrate including a substrate, a plurality of scan lines disposed on the substrate, a plurality of data lines disposed on the substrate, a first pixel rows disposed on the substrate and a second pixel group disposed on the substrate is provided. The first pixel group has a first reflective region and a first transmissive region. The second pixel group has a second transmissive region and a second reflective region, the first pixel group and the second pixel group are controlled by the scan lines and the data lines and arranged alternatively along a column direction, wherein the first transmissive region is contiguous to the second transmissive region.

### BACKGROUND OF THE INVENTION

1. Field of Invention

The present invention relates to a thin film transistor array (TFT array). More particularly, the present invention relates to a transflective thin film transistor liquid crystal display (TFT-LCD) with high aperture ratio.

2. Description of Related Art

To match the life style of modern people, video or imaging equipment is becoming lighter and slimmer. Although the conventional cathode ray tube (CRT) has many advantages, the design of the electron gun renders it heavy and bulky. Moreover, there is always some danger of hurting viewer's eyes due to the production of a little radiation. With big leaps in the techniques in manufacturing semiconductor devices and opto-electronic devices, flat panel displays such as liquid crystal displays (LCD), organic light-emitting displays (OLED) and plasma display panels (PDP) has gradually become the mainstream display products.

Depending on the light source, a liquid crystal display can be classified as three types: the reflective LCD, the transmissive LCD and the transflective LCD. Taking a transflective LCD as an example, the transflective LCD mainly includes a liquid crystal panel and a back light module. The transflective LCD panel includes two transparent substrates and a liquid crystal layer sandwiched therebetween. The back light module provides a surface light source to illuminate the liquid crystal panel for displaying some images. More specifically, the transflective LCD panel includes a plurality of pixels each having a transmissive region and a reflective region respectively, wherein the transmissive region and the reflective region have different cell-gaps.

FIG. 1 is a schematic top view of a conventional transflective LCD panel; FIG. 2 is schematic sectional view taken along line A-A of the conventional transflective LCD panel in FIG. 1. Referring FIG. 1 and FIG. 2, the conventional transflective LCD panel 100 includes a thin film transistor array 110, a color filter 120 and a liquid crystal layer 130. The color filter 120 is disposed above the thin film transistor array 110, and the liquid crystal layer 130 is sandwiched between the thin film transistor array 110 and the color filter 120.

Referring FIG. 1 and FIG. 2, in the conventional thin film transistor array 110, a plurality of transflective pixels P are defined thereon. Each transflective pixel P includes a transmissive region T and a reflective region R. Since a protrusion layer 122 is formed on a surface of the color filter 120, a cell-gap G/2 is formed between the reflective region R of the transflective pixel P and the color filter 120, while a cell-gap G is formed between the transmissive region T of the transflective pixel P and the color filter 120.

As shown in FIG. 1 and FIG. 2, in the same column of the thin film transistor array 110, since the reflective region R and the transmissive region T of the pixels P are arranged alternatively, reverse tilt domains D1, D2 are not only generated at an area within the pixel P, but also generated at the edge of each pixel P. More specifically, since thickness-transition areas are formed at the edge of the protrusion layer 122, the reverse tilt domains D1, D2 are generated at the edge of each pixel P and the area within the pixel P that is corresponding to an area between the transmissive region T and the reflective region R of the thin film transistor array 110. Therefore, aperture ratio of the conventional transflective LCD panel 100 is limited by the reverse tilt domains D1 that are generated at the edge of each pixel P. For high definition LCD panels having high aperture ratio, reverse tilt domains must be reduced.

### SUMMARY OF THE INVENTION

The present invention provides a transflective thin film transistor liquid crystal display with high aperture ratio, by structuring the transmissive regions of adjacent pixels to be adjacent. In one embodiment of the present invention, the adjacent transmissive regions are contiguous.

As embodied and broadly described herein, the present invention provides a thin film transistor array substrate including a substrate, a first pixel groups and a second pixel groups disposed on the substrate and arranged along a first direction. The first pixel group has a first reflective region and a first transmissive region, the second pixel group has a second transmissive region and a second region, which are arranged along a second direction, wherein the first direction is perpendicular to the second direction and the first transmissive region is contiguous to the second transmissive region.

As embodied and broadly described herein, the invention provides a transflective thin film transistor liquid crystal display includes the thin film transistor array substrate mentioned above, a color filter substrate disposed above the thin film transistor array substrate, and a liquid crystal layer located between the color filter substrate and the thin film transistor array substrate.

As embodied and broadly described herein, the invention provides a liquid crystal display device comprising the transflective thin film transistor liquid crystal display mentioned above.

As embodied and broadly described herein, the invention provides an electronic device comprising the transflective thin film transistor liquid crystal display mentioned above.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

The accompanying drawings are included to provide a further understanding of the present invention, and are incorporated in and constitute a part of this specification. The drawings illustrate embodiments of the invention and, together with the description, serve to explain the principles of the invention.

FIG. 1 is a schematic top view of a conventional transflective LCD panel.

FIG. 2 is schematic sectional view taken along line A-A of the conventional transflective LCD panel in FIG. 1.

FIG. 3 is a schematic top view of a transflective LCD panel according to one embodiment of the present invention.

FIG. 4 is a schematic sectional view taken along line B-B of the transflective LCD panel in FIG. 3 according to one embodiment of the present invention.

FIG. 5 is a schematic top view of another transflective LCD panel according to one embodiment of the present invention.

FIG. 6 is a schematic sectional view taken along line C-C of another transflective LCD panel in FIG. 5 according to one embodiment of the present invention.

FIG. 7 is a schematic view of an LCD device according to one embodiment of the present invention.

FIG. 8 is a schematic view of an electronic device according to one embodiment of the present invention.

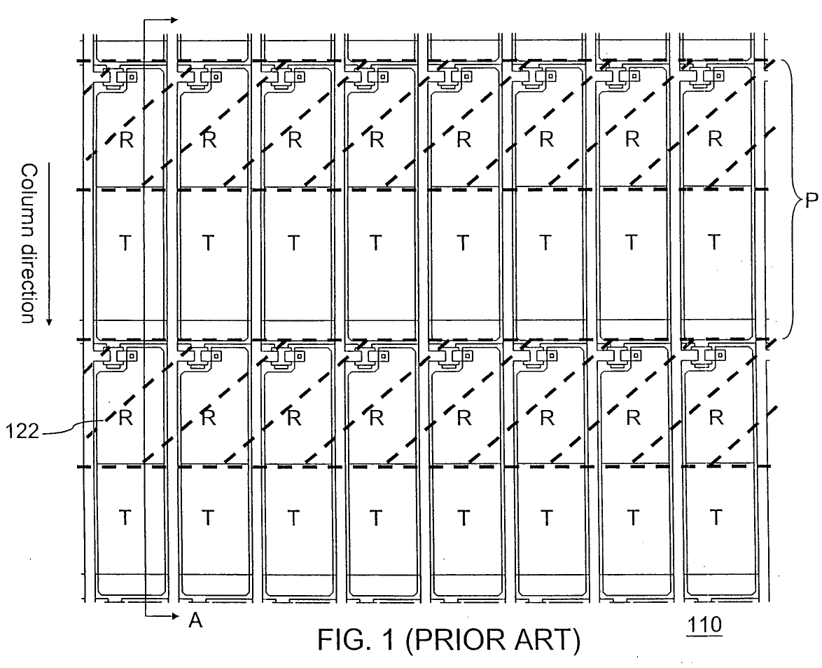

### DESCRIPTION OF THE PREFERRED EMBODIMENTS

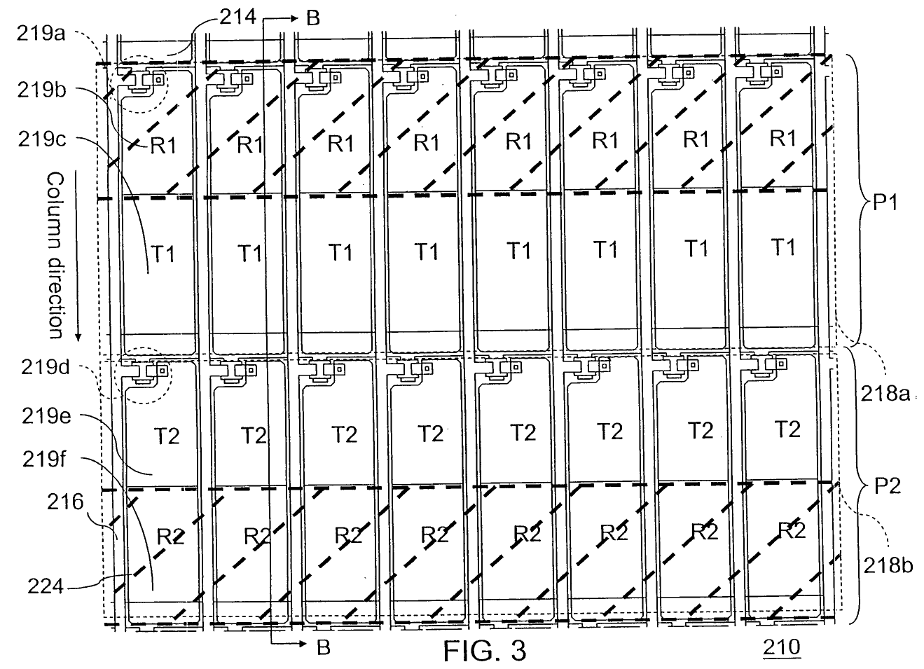

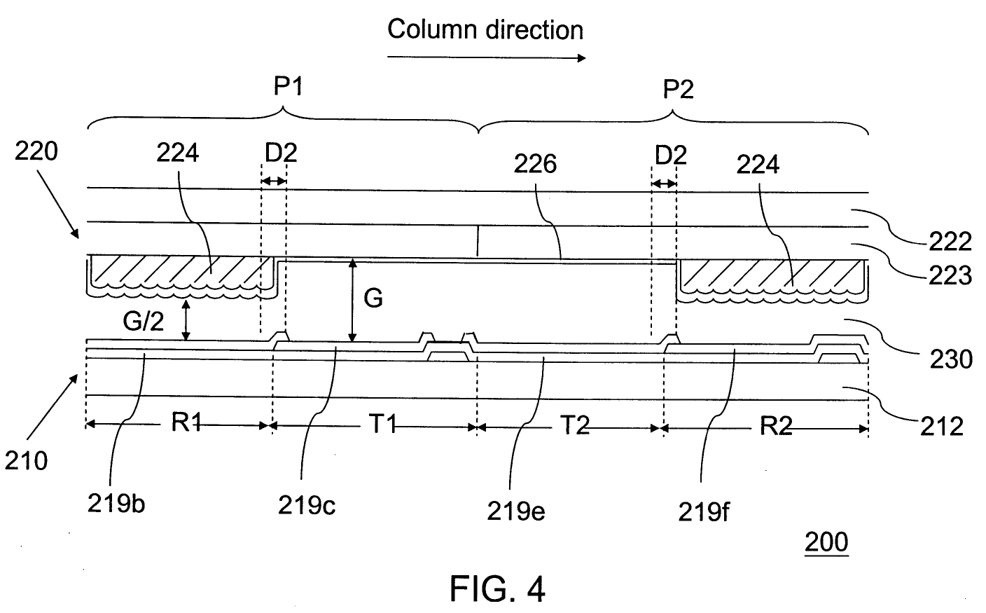

FIG. 3 is a schematic top view of a transflective LCD panel according to one embodiment of the present invention; FIG. 4 is a schematic sectional view taken along line B-B of the transflective LCD panel in FIG. 3 according to one embodiment of the present invention. Referring to FIG. 3 and FIG. 4, the transflective LCD panel 200 of the present invention includes a thin film transistor array substrate 210, a color filter substrate 220 and a liquid crystal layer 230. The color filter substrate 220 is disposed above the thin film transistor array substrate 210, and the liquid crystal layer 230 is sandwiched between the thin film transistor array substrate 210 and the color filter substrate 220.

Referring to FIG. 3 and FIG. 4, in this illustrated embodiment of the present invention, the thin film transistor array substrate 210 includes a substrate 212, a plurality of scan lines 214 disposed on the substrate 212, a plurality of data lines 216 disposed on the substrate 212, a first pixel groups 218a disposed on the substrate 212 and a second pixel groups 218b disposed on the substrate 212. The arrangement of the scan lines 214, the data lines 216, the first pixel groups 218a and the second pixel groups 218b is well-known to skilled artisans, therefore further elaboration is not required for an understanding of the present invention. The first pixel group 218a has a first reflective region R1 and a first transmissive region T1. The second pixel group 218b has a second transmissive region T2 and a second reflective region R2. The first pixel groups 218a and the second pixel groups 218b are controlled by the scan lines 214 and the data lines 216 and arranged alternatively along a column direction. As shown in FIG. 3 and FIG. 4, in the thin film transistor array substrate 210, a sequence of the first reflective regions R1, the first transmissive regions T1, the second transmissive regions T2 and the second reflective regions R2 is arranged along the column direction.

As shown in FIG. 3 and FIG. 4, the first pixel group 218a includes a plurality of first pixels P1 arranged along the row direction, and each first pixel P1 includes a first thin film transistor 219a electrically connected to one of the scan lines 214 and one of the data lines 216, a first reflective electrode 219b electrically connected to the first thin film transistor 219a, and a first transmissive electrode 219c electrically connected to the first reflective electrode 219b, wherein the first reflective electrode 219b and first transmissive electrode 219c are arranged along the column direction.

As shown in FIG. 3 and FIG. 4, the second pixel group 218b includes a plurality of second pixels P2 arranged along the row direction, and each second pixel P2 includes a second thin film transistor 219d electrically connected to one of the scan lines 214 and one of the data lines 216, a second transmissive electrode 219e electrically connected to the second thin film transistor 219d, and a second reflective electrode 219f electrically connected to the second transmissive electrode 219e, wherein the second transmissive electrode 219e and second reflective electrode 219f are arranged along the column direction.

As shown in FIG. 3 and FIG. 4, the color filter substrate 220 includes a second substrate 222, a plurality of color filter films 223 disposed on the second substrate 222, a protrusion layer 224 disposed on the substrate 222 and a common electrode 226 disposed over the second substrate 222. The protrusion layer 224 that comprises a plurality of protrusions is located above the first reflective region R1 and the second reflective region R2. Each protrusion narrows the spacing between the color filter substrate 220 and the thin film transistor array substrate 210. According to various embodiments, a thickness of the spacing located above the first reflective region R1 and the second reflective region R2 can be equal to half thickness of the spacing located above the first transmissive region T1 and the second transmissive region T2. The common electrode 226 covers the color filter films 223 and the protrusion layer 224.

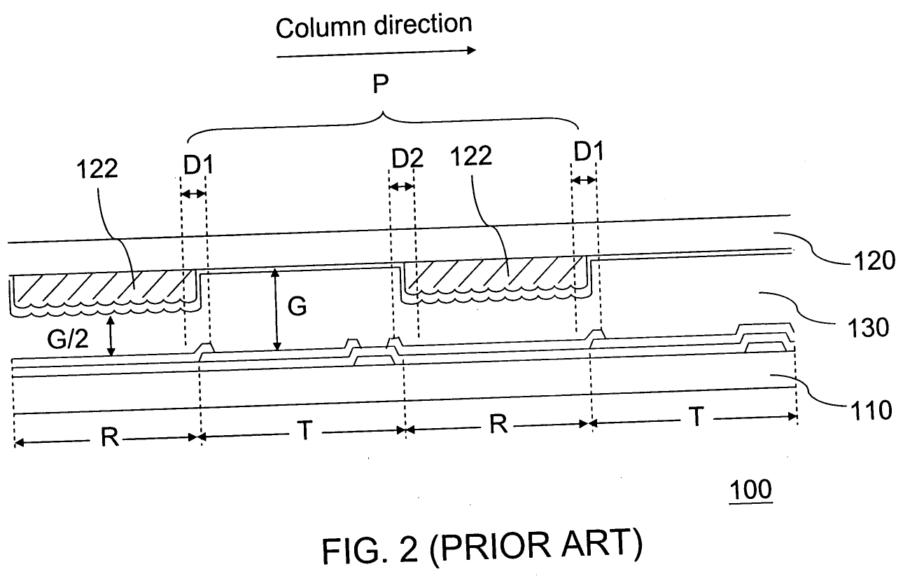

In the same column of the thin film transistor array substrate 210, since the first transmissive region T1 of the first pixels P1 and the second transmissive region T2 of the second pixels P2 are arranged contiguous only reverse tilt domains D2 are generated at an area within the first pixel P1 and the second pixel P2. Therefore, aperture ratio of the transflective LCD panel 200 can be further enhanced because the reverse tilt domains D1 are eliminated at the edge of each first pixel P1 and the second pixel P2, as compared to D1 in FIG. 2.

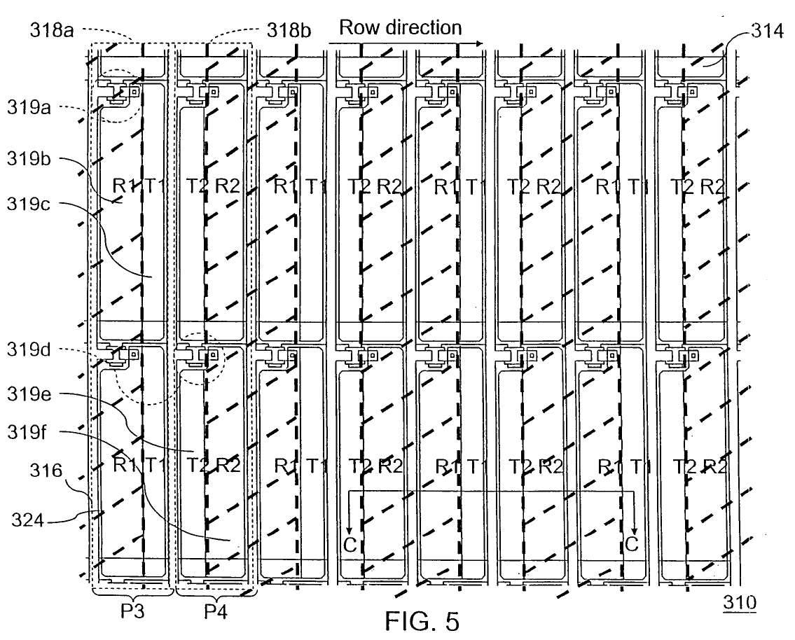

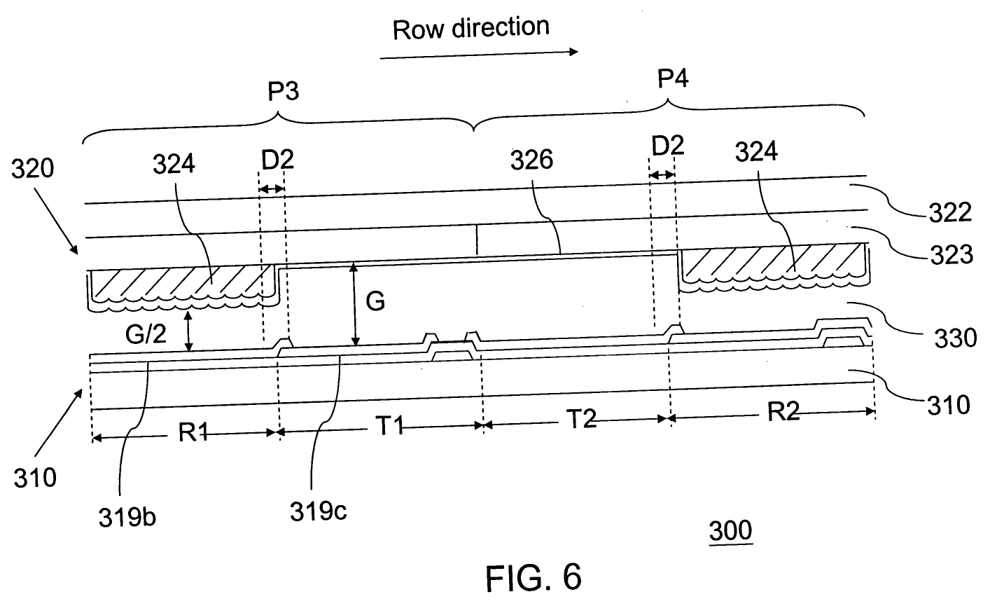

FIG. 5 is a schematic top view of another transflective LCD panel according to one embodiment of the present invention; FIG. 6 is a schematic sectional view taken along line C-C of another transflective LCD panel in FIG. 5 according to one embodiment of the present invention. Referring to FIG. 5 and FIG. 6, the transflective LCD panel 300 of the present invention includes a thin film transistor array substrate 310, a color filter substrate 320 and a liquid crystal layer 330. The color filter substrate 320 is disposed above the thin film transistor array substrate 310, and the liquid crystal layer 330 is sandwiched between the thin film transistor array substrate 310 and the color filter substrate 320.

Referring FIG. 5 and FIG. 6, in the present invention, the thin film transistor array substrate 310 includes a substrate 312, a plurality of scan lines 314 disposed on the substrate 312, a plurality of data lines 316 disposed on the substrate 312, and a first pixel groups 318a disposed on the substrate 312. The first pixel group 318a has a first reflective region R1 and a first transmissive region T1, and a second pixel groups 318b disposed on the substrate 312, the second pixel group 318b has a second transmissive region T2 and a second reflective region R2. The arrangement of the scan lines 314, the data lines 316, the first pixel groups 318a and the second pixel groups 318b is well-known to skilled artisans, therefore detail description is omitted. The first pixel groups 318a and the second pixel groups 318b are controlled by the scan lines 314 and the data lines 316 and arranged alternatively along the row direction. As shown in FIG. 5 and FIG. 6, in the thin film transistor array substrate 310, a sequence of the first reflective regions R1, the first transmissive regions T1, the second transmissive regions T2 and the second reflective regions R2 is arranged along the row direction.

As shown in FIG. 5 and FIG. 6, the first pixel group 318a includes a plurality of third pixels P3 arranged along the column direction, and the third pixel P3 includes a third thin film transistor 319a electrically connected to one of the scan lines 314 and one of the data lines 316, a third reflective electrode 319b electrically connected to the third thin film transistor 319a and a third transmissive electrode 319c electrically connected to the third reflective electrode 319b, wherein the third reflective electrode 319b and third transmissive electrode 319c are arranged along the row direction.

As shown in FIG. 5 and FIG. 6, each second pixel group 318b includes a plurality of fourth pixels P4 arranged along the column direction, and each fourth pixel P4 includes a fourth thin film transistor 319d electrically connected to one of the scan lines 314 and one of the data lines 316, a fourth transmissive electrode 319e electrically connected to the fourth thin film transistor 319d, and a fourth reflective electrode 319f electrically connected to the fourth transmissive electrode 319e, wherein the fourth transmissive electrode 319e and fourth reflective electrode 319f are arranged along the row direction.

As shown in FIG. 5 and FIG. 6, the color filter substrate 320 includes a second substrate 322, a plurality of color filter films 323 disposed on the second substrate 322, a protrusion layer 324 disposed on the substrate 322, and a common electrode 326 disposed over the second substrate 322. The protrusion layer 324 is located above the first reflective region R1 and the second reflective region R2. The common electrode 326 covers the color filter films 323 and the protrusion layer 324.

In the same group of the thin film transistor array substrate 310, since the first transmissive region T1 of the third pixels P3 and the second transmissive region T2 of the fourth pixels P4 are arranged together, only reverse tilt domains D2 are generated at an area within the third pixel P3 and the fourth pixel P4. Therefore, aperture ratio of the transflective LCD panel 300 can be further enhanced because the reverse tilt domains D1 are eliminated at the edge of each third pixel P3 and the fourth pixel P4.

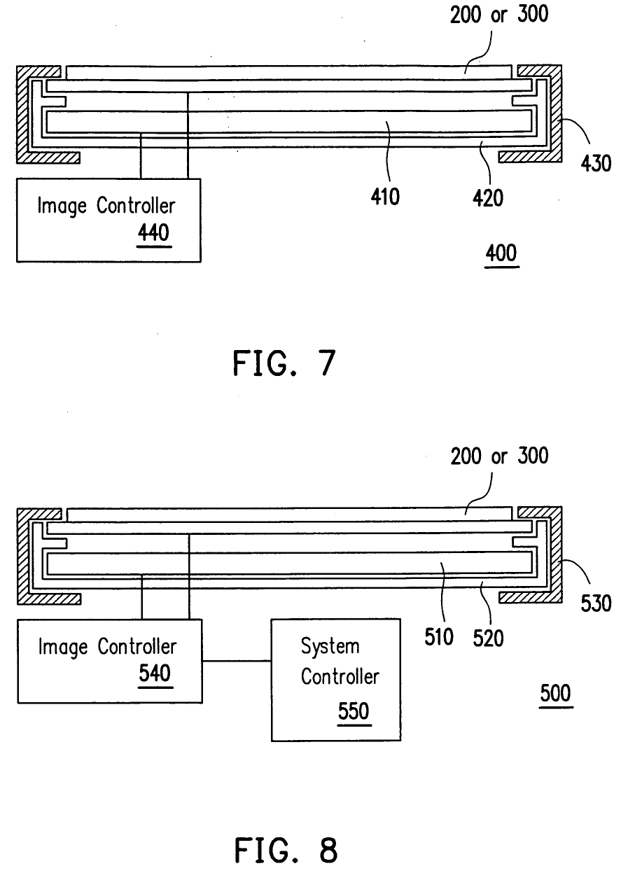

FIG. 7 is a schematic view of an LCD device (e.g., a display monitor) according to one embodiment of the present invention. Referring to FIG. 7, an LCD device 400 including the transflective LCD panel 200 or 300 is provided. For example, the LCD device 400 of the present invention comprises the transflective LCD panel 200 or 300 mentioned above, a back light unit 410, a frame 420, a bezel 430 and an image controller 440. The transflective LCD panel 200 or 300 and the back light unit 410 are carried by the frame 420. The transflective LCD panel 200 or 300, the back light unit 410 and the frame 420 are fastened by the bezel 430. In addition, the image controller 440 is electrically coupled with the transflective LCD panel 200 or 300 and the back light unit 410 by appropriate manners.

FIG. 8 is a schematic view of an electronic device (e.g., a notebook computer, personal digital assistant, digital camera, etc.) according to one embodiment of the present invention. Referring to FIG. 8, an electronic device 500 including the transflective LCD panel 200 or 300 is provided. For example, the electronic device 500 of the present invention comprises the transflective LCD panel 200 or 300 mentioned above, a back light unit 510, a frame 520, a bezel 530, an image controller 540 and a system controller 550 implementing the control functions for the particular electronic device. The system controller may include components such as a data source, a data interface, etc. The transflective LCD panel 200 or 300 and the back light unit 510 are carried by the frame 520. The transflective LCD panel 200 or 300, the back light unit 510 and the frame 520 are fastened by the bezel 530. In addition, the image controller 540 and the system controller 550 are electrically coupled with the transflective LCD panel 200 or 300 and the back light unit 510 directly or in directly by appropriate manners.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A thin film transistor array substrate, comprising:
a substrate;
a first pixel group disposed on the substrate, the first pixel group comprising a plurality of first pixels arranged along a first direction, the first pixel comprising a first reflective region and a first transmissive region arranged along a second direction, wherein the first direction is perpendicular to the second direction; and
a second pixel group disposed on the substrate, the second pixel group comprising a plurality of second pixels arranged along the first direction, the second pixel comprising a second transmissive region and a second reflective region arranged along the second direction, wherein the first transmissive region is contiguous to the second transmissive region.

2. The thin film transistor array structure as in claim 1, wherein the first reflective region is defined by a first reflective electrode and the first transmissive region is defined by a first transmissive electrode, and the second reflective region is defined by a second reflective electrode and the second transmissive region is defined by a second transmissive electrode.

3. The thin film transistor array substrate of claim 1, wherein each first pixel further comprising:
a scan line disposed on the substrate;
a data lines disposed on the substrate; and
a thin film transistor electrically connect to the scan line and the data line.

4. The thin film transistor array substrate of claim 1, wherein each second pixel further comprising:
a scan line disposed on the substrate;
a data lines disposed on the substrate; and
a thin film transistor electrically connect to the scan line and the data line.

5. A transflective display panel, comprising:
a thin film transistor array substrate as in claim 1;
a color filter substrate disposed related to the thin film transistor array substrate to define a spacing therebetween; and
a liquid crystal layer located between the thin film transistor substrate and the color filter substrate.

6. The transflective display panel of claim 5, wherein the color filter substrate defines a filter transmissive region for both the first transmissive region and the second transmissive region.

7. The transflective display panel of claim 6, wherein the filter transmissive region provides contiguous coverage of the first transmissive region and the second transmissive region.

8. The transflective display panel of claim 5, wherein the color filter substrate comprising:
a second substrate;
a plurality of color filter films disposed on the second substrate;
a protrusion layer disposed on the second substrate; and
a common electrode disposed on the second substrate, wherein the common electrode covers the color filter films and the protrusion layer.

9. The transflective display panel of claim 8, wherein the protrusion layer comprising a first protrusion and a second protrusion that narrow the spacing between the color filter substrate and the thin film transistor array substrate at the first and second reflective regions.

10. The transflective display panel of claim 9, wherein the first and second protrusions narrow the spacing between the first and second protrusions and the first and second reflective regions, respectively.

11. The transflective display panel of claim 10, wherein a thickness of the spacing located above the first reflective region and the second reflective region can be equal to half thickness of the liquid crystal layer located above the first transmissive region and the second transmissive region.

12. A display device, comprising:
a transflective display panel as in claim 5; and
an image controller coupled to the transflective display panel to control the transflective display panel to render an image.

13. An electronic device, comprising:
a display device as in claim 12; and
a system controller coupled to the controller of the display device to render an image.
